(19) United States
(12) Patent Application Publication
(10) Pub. No.: US 2018/0215516 A1
(43) Pub. Date: Aug. 2, 2018

(54) INTERNALLY VENTED GAS CAN HAVING A SINGLE BALL VALVE COMPONENT

(71) Applicant: Dwayne R. Hershberger, Hillsville, VA (US)

(72) Inventor: Dwayne R. Hershberger, Hillsville, VA (US)

(21) Appl. No.: 15/423,090

(22) Filed: Feb. 2, 2017

(51) Int. Cl. B65D 51/16; B65D 47/06; B65D 47/32; B67D 3/00; B65D 47/30

(52) U.S. Cl. CPC B65D 51/1644; B65D 47/068; B65D 47/30; B67D 3/0051; B65D 47/32

(57) ABSTRACT

A container for fluids having a body, a first fluid passage, a second fluid passage, and a control mechanism is disclosed. The control mechanism is for controlling flow through the first fluid passage and the second fluid passage and is in the preferred construction a ball valve having a first aperture and a second aperture, such that both of the passages are simultaneously controlled by the ball valve. The first fluid passage is for allowing egress of a fluid stored in the chamber of the container, and the second fluid passage is for allowing air return to avoid negative pressure in the chamber. The container has a spout which is oriented in coordination with the second fluid passage so as to avoid liquid flow through the second fluid passage.

### BACKGROUND OF THE INVENTION

### Field of the Invention

The present invention relates to a storage container for volatile fluids, and more particularly, an INTERNALLY VENTED GAS CAN HAVING A SINGLE BALL VALVE COMPONENT.

### Description of the Prior Art

Numerous innovations for gasoline storage have been provided in the prior art that will be described. Even though these innovations may be suitable for the specific individual purposes to which they address, however, they differ from the present invention.

A FIRST EXAMPLE, U.S. Pat. No. 1,662,978, Published/Issued on Mar. 20, 1928, to Meissner teaches a gasoline receptacle 1, valve casing 2, valve member 3, cap 4, spring 5, initial burner 6, gasoline feed pipe 7, air feed pipe 8, and burner 9, constitute the principal parts and portions of my gasoline lantern valve mechanism.

The receptacle 1 is of the ordinary or conventional type provided with an internally threaded orifice in its central upper portion and is provided with the usual pressure pump 1 in one side thereof. Secured in the orifice 1 is the lower extended portion 2 of the valve casing 2 by means of the threads 2 This valve casing is provided with two ports 2 and 2 which extend therethrough, and with a tapered central recess 2 adapted for the tapered valve member 3 to fit tightly therein.

A SECOND EXAMPLE, U.S. Pat. No. 2,273,737, Published/Issued on Feb. 17, 1942, to Snyder teaches a vent device which is more particularly intended for use in connection with gasoline containers although the same may also be used advantageously in connection with containers of other materials which are subject to similar conditions.

A THIRD EXAMPLE, U.S. Pat. No. 3,921,664, Published/Issued on Nov. 25, 1975, to Almquist teaches a vacuum powered motor device which can be inserted in the fuel line of a motor vehicle between the fuel pump and the carburetor. The device comprises a valve having an inlet pipe and an outlet pipe with a fuel valve diaphragm vacuum chamber therebetween. When the fuel flows into the inlet pipe, the fuel flow causes the diaphragm to be moved downwardly, thereby freeing a passage across which the diaphragm sits. The vacuum created in the energy chamber under such conditions causes the diaphragm to freeze against the action of resilient means such as a coil spring which thereby controls the precise amount of fuel passing into the valve chamber and thereafter through the outlet port to the carburetor. With this construction there is a steady even flow with the desired amount of fuel.

A FOURTH EXAMPLE, U.S. Pat. No. 4,746,036, Published/Issued on May 24, 1988, to Messner teaches a container for gasoline or other liquids is provided with a hollow body portion equipped with a pouring spout. A manually actuated valve mechanism plugs or unplugs the pouring spout by the axial displacement of a control rod which extends through both the pouring spout and the container body. The plug and control rod being biased towards a closed position and displaceable to a locked open position. In the locked open position the interior of the hollow body portion is vented via a vent tube, ventable to either the upper or lower portions of the container. The air admission system including a pair of pressure-actuated valves disposed respectively in the upper and lower portions of the vent tube and each operable to admit air to the container only when it is not submerged in the container contents. Thus, the flow of fluid will be continuous whether the container is upright or inverted.

A FIFTH EXAMPLE, U.S. Pat. No. 7,204,394, Published/Issued on Apr. 17, 2007, to Tackett teaches a container for storing and dispensing liquids such as gasoline has a gate valve wherein the gate valve comprises a thin, substantially flat slide member optionally angled at a portion thereof. The gate valve member is slidably positioned within a similarly shaped channel formed into a surface of a reservoir (storage) portion of the container, or other area of the container.

A SIXTH EXAMPLE, U.S. Pat. No. 7,445,136, Published/Issued on Nov. 4, 2008, to Lin teaches a valve includes a shell defining a space and an aperture through which gas can go into the space. A tube is movable in the space of the shell between a first position for opening the aperture of the shell and a second position for closing the aperture of the shell. The tube includes a tunnel defined therein and an internal annular flange formed on the wall of the tunnel. A seal is located between the tube and the shell. A spring is compressed between the tube and the shell. A core is located in the tube so as to abut the internal annular flange of the tube in the first position of the tube. A rod is formed on a closed end of the space of the shell so as to push the core from the internal annular flange of the tube in the second position of the tube.

A SEVENTH EXAMPLE, U.S. Pat. No. 7,802,704, Published/Issued on Sep. 28, 2010, to Hatch, et al. teaches a gasoline can having a nozzle assembly which includes a ball valve that is in an open mode when the can's nozzle is lifted for pouring, and which when the can's nozzle is in a lowered storage mode, the ball valve is closed.

AN EIGHTH EXAMPLE, U.S. Patent Office Document No. 20060027272, Published/Issued on Feb. 9, 2006, to Tomlinson, et al. teaches a valve assembly for metal hydride hydrogen storage (MHHS) or chemical hydride hydrogen storage (CHHS) devices. The valve assembly comprises a body with an inlet connector for connecting to the MHHS or CHHS device, an outlet connector for connecting to an external device, a cavity in the body that is in gas communication with the inlet and outlet connectors, and a shut-off valve in the cavity that can be moved between an opened position that permits gas flow between the inlet and outlet connectors, and a closed position that denies said gas flow. The outlet connector has a first valve therein that is biased to remain closed when external pressure thereon is less than or equal to ambient pressure, thereby impeding at least atmospheric gas backflow into the cavity. The outlet connector can also have a second, one-way valve that permits gas flow out of the valve assembly only, as well as a bypass mechanism including a gas passage coupled to the cavity and upstream of the first and second valves, through which gas can be transmitted to the canister during charging.

It is apparent now that numerous innovations for ventilated and volatile storage have been provided in the prior art that adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide an INTERNALLY VENTED GAS CAN HAVING A SINGLE BALL VALVE COMPONENT that avoids the disadvantages of the prior art.

ANOTHER OBJECT of the present invention is to provide an INTERNALLY VENTED GAS CAN HAVING A SINGLE BALL VALVE COMPONENT that is simple and inexpensive to manufacture.

STILL ANOTHER OBJECT of the present invention is to provide an INTERNALLY VENTED GAS CAN HAVING A SINGLE BALL VALVE COMPONENT that is simple to use.

BRIEFLY STATED, STILL YET ANOTHER OBJECT of the present invention is to provide an INTERNALLY VENTED GAS CAN HAVING A SINGLE BALL VALVE COMPONENT that allows for return air to fill the chamber of the can while preventing leakage or unintentional leaving open of the gas can.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWINGS

The figures of the drawings are briefly described as follows:

FIG. 1 is a diagrammatic perspective illustrating the INTERNALLY VENTED GAS CAN HAVING A SINGLE BALL VALVE COMPONENT in use;

FIG. 2 is a diagrammatic partial cross sectional view through the gas can and spout;

FIG. 3 is a longitudinal cross sectional view taken in the area enclosed in the dotted circle indicated by bold numeral 3 in FIG. 2, with parts broken away, through the spout and valve which permits transferring of the fluids;

FIG. 4 is a longitudinal cross sectional view, with parts broken away, through the spout and valve which prevents transferring of the fluids; and

FIG. 5 is cross sectional view taken on line 5-5 in FIG. 3.

### A MARSHALING OF REFERENCE NUMERALS UTILIZED IN THE DRAWINGS

10 container
12 body
14 first fluid passage
16 second fluid passage
18 control mechanism
20 chamber of body 12
22 spout
24 proximal end of spout 22
26 distal end of spout 22
28 first terminus of first fluid passage 14
30 second terminus of first fluid passage 14
32 first terminus of second fluid passage 16
34 second terminus of second fluid passage 16
36 spout 22 portion of second fluid passage 16
38 body 12 portion of second fluid passage 16
39 top of chamber 20
40 threading
42 valve of control mechanism 18
43 rotatable control of control mechanism 18
44 ball of valve 42 of control mechanism 18
46 first aperture of ball 44 of quarter turn ball valve 42
of control mechanism 18
48 second aperture of ball 44 of quarter turn ball valve 42
of control mechanism 18
50 spring of control mechanism 18
51 lower corners of body 12
52 first upper corner of body 12
54 second upper corner of body 12
56 first handle
58 second handle
60 mark of spout 22
62 mark of body 12

### DETAILED DESCRIPTION OF THE PREFERRED EMBODIMENT

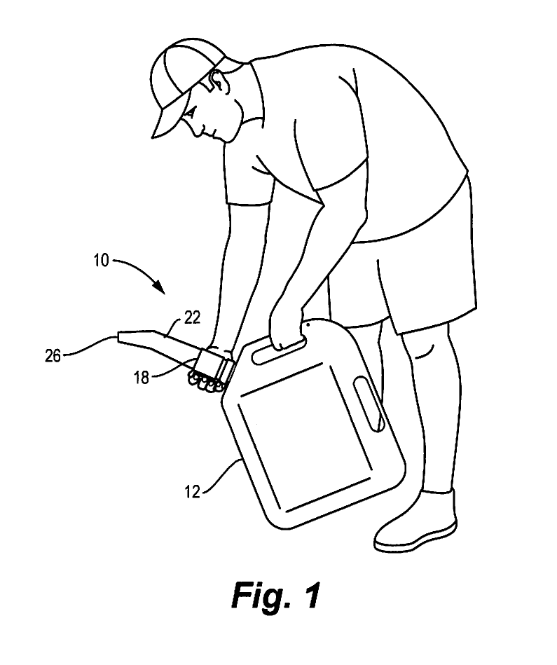

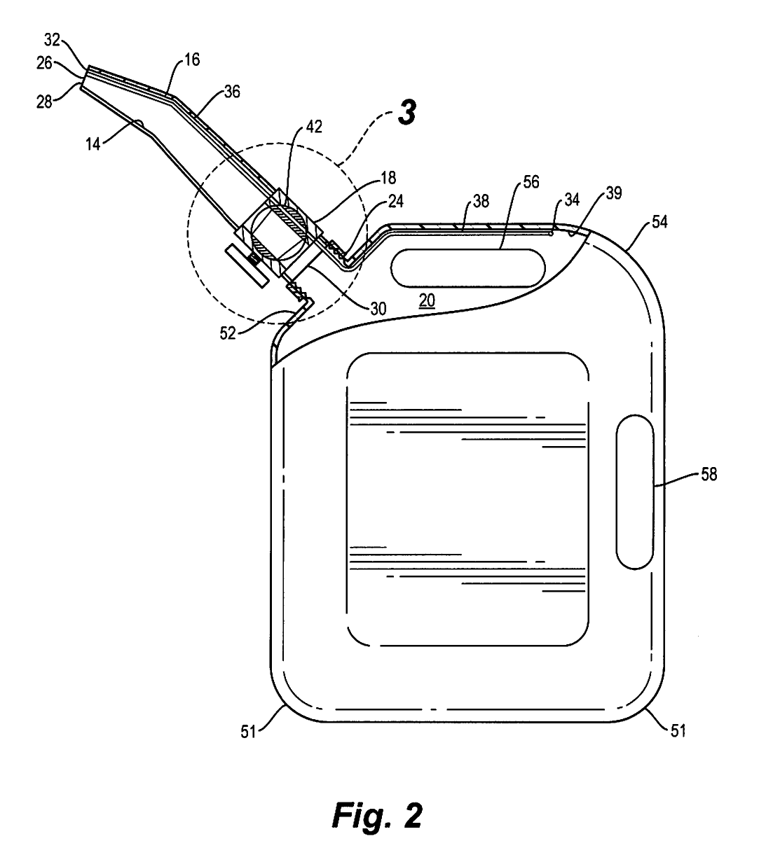

Referring now to the figures, in which like numerals indicate like parts, and particularly to FIGS. 1 and 2, disclosed is a container 10 for fluids, especially for gasoline or other volatile fuels, which has:

a) a body 12;

b) a first fluid passage 14;

c) a second fluid passage 16; and

d) a control mechanism 18.

The body 12 is hollow and forms a chamber 20 for storing a fluid. The first fluid passage 14 extends from the body 12. The second fluid passage 16 likewise extends from the body 12. The control mechanism 18 simultaneously controls whether the first fluid passage 14 is open, and whether the second fluid passage 16 is open. In use, the preferred usage is that the first fluid passage 14 is for transporting gasoline or another liquid out of the chamber 20, and the second fluid passage is for allowing air or another refilling fluid to enter the chamber so as to avoid a negative pressure in the chamber 20 when pouring a liquid. Negative pressure has detrimental effects on many fluids, especially volatile fluids which are prone to rapid evaporation in a low pressure environment.

### Detailed Description of the Preferred Construction of the First Fluid Passage 14 and the Second Fluid Passage 16

As illustrated in FIGS. 1 and 2, the container 10 further has a spout 22. The spout 22 has a proximal end 24 and a distal end 26. The proximal end 24 of the spout 22 is attached to the body 12. The distal end 26 of the spout 22 is extended away from the body 12. This structure aids in using the container 10 for filling a motor vehicle or the like. In that application, long spouts 22 are desirable, but long spouts 22 create a large negative pressure problem and frequently have substantial bubbling problems with air bubbles traveling up the spout to equalize pressure. This is especially undesirable for fluids like gasoline where spillage can be dangerous due to volatility and flammability.

The first fluid passage 14 has a first terminus 28 and a second terminus 30. The second fluid passage 16 has a first terminus 32 and a second terminus 34. The first terminus 28 of the first fluid passage 14 and the first terminus 32 of the second fluid passage 16 are both at the distal end 26 of the spout 22 of the container 10. This construction simplifies manufacture of the container 10.

The first terminus 28 of the first fluid passage 14 is disposed below the first terminus 32 of the second fluid passage 16 at the distal end 26 of the spout 22. This assures that fluid exiting from the chamber 20 does not cover or block the first terminus 32 of the second fluid passage 16 which as previously remarked is for allowing return air or other fill fluid.

The second terminus 30 of the first fluid passage 14 is at the proximal end 24 of the spout 22. This simplifies construction and allows free flow of fluid from the chamber 20 of the body 12.

The second terminus 34 of the second fluid passage 16 is inside the body 12 of the container 10. This construction makes it so that fluid can flow out of the first fluid passage 14 without also flowing out of the second fluid passage 16.

The second fluid passage 16 has a spout portion 36 and a body portion 38. The spout portion 36 of the second fluid passage 16 is in the spout 22. The body portion 38 of the second fluid passage 16 is in the body 12. The attachment of the proximal end 24 of the spout 22 to the body 12 fluidly connects the spout portion 36 of the second fluid passage 16 to the body portion 38 of the second fluid passage 16. This construction allows the spout 22 to be removable, thereby removing the need for a second filling aperture for the container 10 and simplifying construction, as well as minimizing leakage opportunities, which is important for volatile fluids prone to evaporation such as gasoline.

The second terminus 34 of the second fluid passage 16 is at the top 39 of the chamber 20 of the body 12 of the container 10. This prevents flow of a liquid fluid through the second fluid passage 16 and prevents return air from bubbling through any liquid stored in the chamber 20.

The attachment of the spout 22 to the body 12 is by thread 40 so as to permit removal of the spout 22 by a user unthreading the spout 22, or attachment by threading the spout 22. It is to be understood that as used in this specification thread and threading refer to screw threads, and not to strings or lanyards.

The thread 40 attachment of the spout 22 to the body 12 constitutes a single thread 40 so as to cause the body portion 38 of the second fluid passage 16 and the spout portion 36 of the second fluid passage 16 to substantially align when the spout 22 is fully attached to the body 12.

### Detailed Description of the Control Mechanism 18

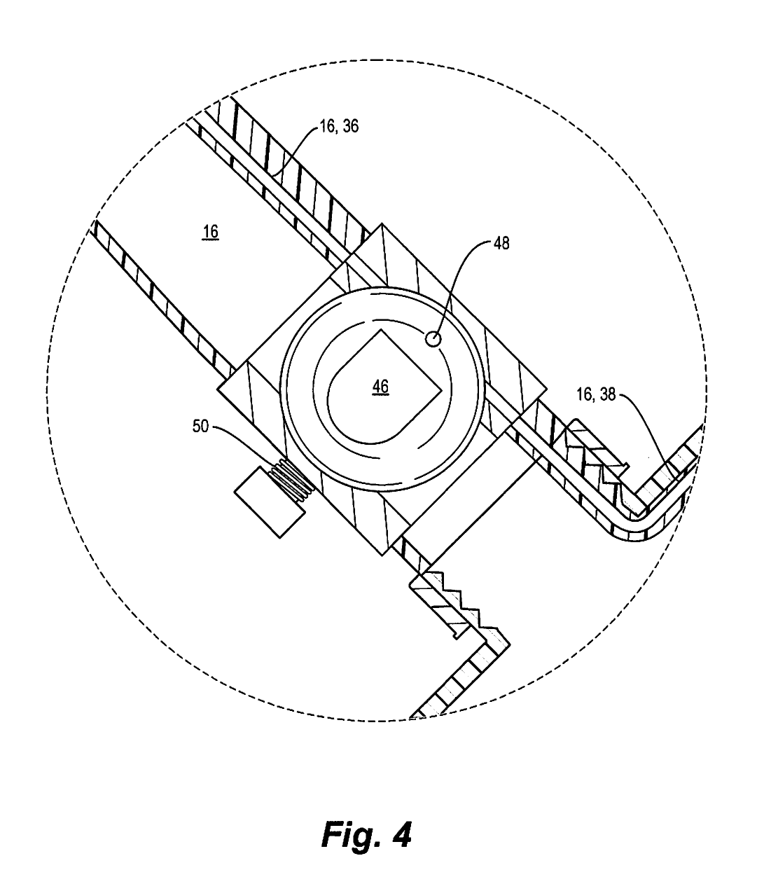

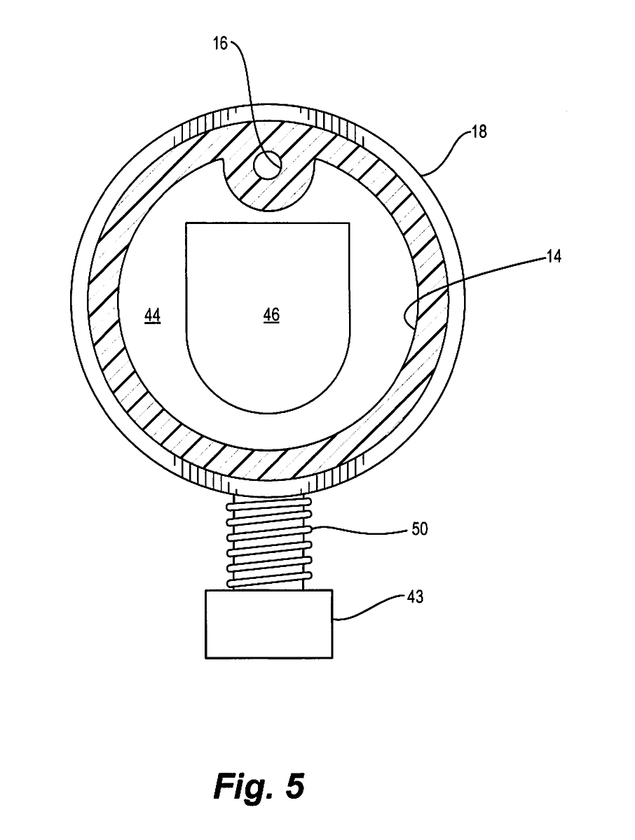

As best illustrated in FIGS. 2, 3, 4, and 5, the control mechanism 18 has, in the preferred embodiment, a valve 42. The valve 42 either seals both the first fluid passage 14 and the second fluid passage 16, or permits flow through the first fluid passage 14 and the second fluid passage 16. To simplify construction and make use easier when pouring, the valve 42 is part of the spout 22 of the container 10. valve is rotatably controllable by a user.

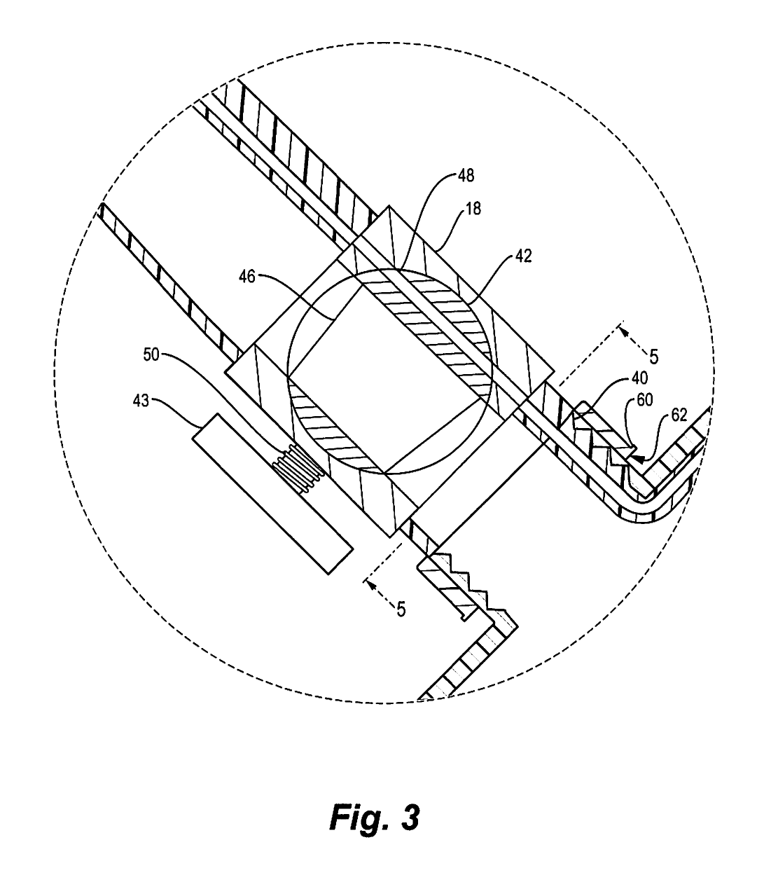

The valve 42 is a quarter-turn valve 42. The valve 42 has a floating element. In the preferred construction, the floating element is a ball 44 and the valve 42 is a quarter-turn ball valve. The floating element has a first aperture 46 and a second aperture 48. As shown in FIG. 3 most clearly, the first aperture 46 permits flow through the first fluid passage 14 when in an open position. The second aperture 16 permits flow through the second fluid passage 16 when in an open position. This structure permits a single ball 44 of the valve 42 to synchronously control both the first fluid passage 14 and the second fluid passage 16.

The rotatable control 43 of the ball valve 42 is biased by a spring 50. The spring 50 biases the rotatable control 43 of the ball valve 42 in a closed direction such that when torque is not applied to the rotatable control 43, the ball valve is pushed into a closed position. This prevents a user from accidentally leaving both apertures open, and requires active user intervention to keep flow going, which is an important safety feature for containers 10 of volatile or flammable fluids.

### Detailed Description of the Body 12

As seen in FIG. 2, the body 12 is substantially rectangular shaped in profile. The rectangular shape of the body 12 has two upper corners which are not for being disposed on the ground, and two lower corners 51 which are for being disposed on the ground. The two upper corners are a first upper corner 52 and a second upper corner 54. The spout 22 extends from the first upper corner 52 of the rectangular shape of the body 12.

The second terminus 30 of the second fluid passage 16 is disposed at the second upper corner 54 of the rectangular shape. This causes the second terminus 30 of the second fluid passage 16 to be above any liquid stored in the chamber 20 when it is tilted by a user to be poured.

As illustrated in FIGS. 1 and 2, the body further has a first handle 56. The first handle is disposed between the first upper corner 52 and the second upper corner 54. This structure aids a user by guiding them to hold the device in the proper orientation for the second terminus 30 of the second fluid passage 16 to be above any liquid in the chamber 20.

The body further has a second handle 58. The second handle 58 is disposed between the second upper corner 54 and the most proximal of the lower corners 51 to the second upper corner 54. The second handle 58 is useful for applications where it is necessary to tilt the container 10 to a large degree while still maintaining the second terminus 30 of the second fluid passage 16 to be above any liquid in the chamber 20.

In the preferred structure, the first handle 56 and the second handle 58 are cut out from the body 12 with the cut outs being sealed. This structure provides maximum volume of fluid storage while assuring that the second terminus 30 of the second fluid passage 16 is above any liquid in the chamber, while also assuring the body portion 38 of the second fluid passage 16 is not traversing a path which would cause siphoning or fluid to become caught in it by being unable to flow uphill when the container 10 is laid on the ground, as would be the case with, for instance, an upwardly bowed handle.

Further to the goal of preventing fluid from flowing un unwanted directions, the spout 22 is angled such that the distal end 36 of the spout 22 is higher than the second terminus 34 of the second fluid passage 16 when both of the two lower corners 51 are disposed on the ground. This prevents unwanted liquid fluid flow from exiting the second fluid passage 16.

In the preferred construction, the spout 22 further has a mark 60. The body 12 further has a mark 62. The mark 60 of the spout 22 and the mark 62 of the body 12 are for being aligned when the spout 22 is attached to the body 12 by the thread 40 such that when the mark 62 of the body 12 and the mark 60 of the spout 22 are aligned, the spout portion 36 of the second fluid passage 16 and the body portion 38 of the second fluid passage 16 are aligned. The mark 60 of the spout 22 is disposed on the proximal end 24 of the spout 22. This structure uses the thread 40 to align the fluid paths roughly and then the mark 60 of the spout 22 and the mark 62 of the body 12 to align them precisely.

### Detailed Description of the Method of Using the Container 10

Disclosed now is a method of utilizing a container 10 which has:

a) a body 12;

b) a first fluid passage 14;

c) a second fluid passage 16; and

d) a control mechanism 18.

The body 12 is hollow and forms a chamber 20 for storing a fluid. The first fluid passage 14 extends from the body 12. The second fluid passage 16 likewise extends from the body 12. The control mechanism 18 simultaneously controls whether the first fluid passage 14 is open, and whether the second fluid passage 16 is open.

The container 10 further has a spout 22. The spout 22 has a proximal end 24 and a distal end 26. The proximal end 24 of the spout 22 is attached to the body 12. The distal end 26 of the spout 22 is extended away from the body 12.

The first fluid passage 14 has a first terminus 28 and a second terminus 30. The second fluid passage 16 has a first terminus 32 and a second terminus 34. The first terminus 28 of the first fluid passage 14 and the first terminus 32 of the second fluid passage 16 are both at the distal end 26 of the spout 22 of the container 10.

The first terminus 28 of the first fluid passage 14 is disposed below the first terminus 32 of the second fluid passage 16 at the distal end 26 of the spout 22.

The control mechanism 18 has a valve 42. The valve 42 either seals both the first fluid passage 14 and the second fluid passage 16, or permits flow through the first fluid passage 14 and the second fluid passage 16.

The second terminus 30 of the first fluid passage 14 is at the proximal end 24 of the spout 22. The second terminus 34 of the second fluid passage 16 is inside the body 12 of the container 10.

The second fluid passage 16 has a spout portion 36 and a body portion 38. The spout portion 36 of the second fluid passage 16 is in the spout 22. The body portion 38 of the second fluid passage 16 is in the body 12. The attachment of the proximal end 24 of the spout 22 to the body 12 fluidly connects the spout portion 36 of the second fluid passage 16 to the body portion 38 of the second fluid passage 16.

The attachment of the spout 22 to the body 12 is by thread 40 so as to permit removal of the spout 22 by a user unthreading the spout 22, or attachment by threading the spout 22. The thread 40 attachment of the spout 22 to the body 12 constitutes a single thread 40 so as to cause the body portion 38 of the second fluid passage 16 and the spout portion 36 of the second fluid passage 16 to substantially align when the spout 22 is fully attached to the body 12.

The spout 22 further has a mark 60. The body 12 further has a mark 62. The mark 60 of the spout 22 and the mark 62 of the body 12 are for being aligned when the spout 22 is attached to the body 12 by the thread 40 such that when the mark 62 of the body 12 and the mark 60 of the spout 22 are aligned, the spout portion 36 of the second fluid passage 16 and the body portion 38 of the second fluid passage 16 are aligned. The mark 60 of the spout 22 is disposed on the proximal end 24 of the spout 22.

The method has the steps of:
Step A: Removing the spout 22 from the body 12 by unthreading;
Step B: Filling the body 12 with a fluid;
Step C: Attaching the spout 22 to the body by threading;
Step D: Aligning the mark 60 of the spout 22 with the mark 62 of the body 12;
Step E: Opening the valve 42 of the control mechanism 18;
Step F: Tilting the body 12 so as to cause the fluid to exit via the first fluid passage 14; and
Step G: Closing the valve 42 of the control mechanism 18.

In the preferred method, the valve 42 is rotatably controllable by a user. The rotatable control 43 of the valve 42 is biased by a spring 50. The spring 50 biases the rotatable control 43 of the valve 42 in a closed direction such that when torque is not applied to the rotatable control 43, the valve 42 is pushed into a closed position. Therefore, in the preferred method, Step G is the step of closing the valve 42 of the control mechanism 18 by releasing the rotatable control 43.

It will be understood that each of the elements described above, or two or more together, may also find a useful application in other types of constructions differing from the types described above.

While the invention has been illustrated and described as embodiments of an INTERNALLY VENTED GAS CAN HAVING A SINGLE BALL VALVE COMPONENT, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A container for fluids for which comprises:
a) a body;
b) a first fluid passage;
c) a second fluid passage; and
d) a control means;
wherein said body is hollow and forms a chamber for storing a fluid;
wherein said first fluid passage extends from said body;
wherein said second fluid passage extends from said body;
wherein said control means simultaneously controls whether said first fluid passage is open, and whether said second fluid passage is open.

2. The container of claim 1 wherein said container further comprises a spout;
wherein said spout has a proximal end and a distal end;
wherein said proximal end of said spout is attached to said body; and
wherein said distal end of said spout is extended away from said body.

3. The container of claim 2 wherein said first fluid passage comprises a first terminus and a second terminus;
wherein said second fluid passage comprises a first terminus and a second terminus; and
wherein said first terminus of said first fluid passage and said first terminus of said second fluid passage are both at said distal end of said spout of said container.

4. The container of claim 3 wherein said first terminus of said first fluid passage is disposed below said first terminus of said second fluid passage at said distal end of said spout.

5. The container of claim 4 wherein said second terminus of said first fluid passage is at said proximal end of said spout.

6. The container of claim 5 wherein said second terminus of said second fluid passage is inside said body of said container.

7. The container of claim 6 wherein said second fluid passage comprises a spout portion and a body portion;
wherein said spout portion of said second fluid passage is in said spout;
wherein said body portion of said second fluid passage is in said body; and
wherein said attachment of said proximal end of said spout to said body fluidly connects said spout portion of said second fluid passage to said body portion of said second fluid passage.

8. The container of claim 7 wherein said second terminus of said second fluid passage is at the top of said chamber of said body of said container.

9. The container of claim 8 wherein said attachment of said spout to said body is by thread so as to permit removal of said spout by a user unthreading said spout, or attachment by threading said spout.

10. The container of claim 9 wherein said threading attachment of said spout to said body comprises a single thread so as to cause said body portion of said second fluid passage and said spout portion of said second fluid passage to substantially align when said spout is fully attached to said body.

11. The container of claim 4 wherein said control means comprises a valve;
wherein said valve either seals both said first fluid passage and said second fluid passage, or permits flow through said first fluid passage and said second fluid passage.

12. The container of claim 11 wherein said valve is part of said spout of said container.

13. The container of claim 12 wherein said valve is rotatably controllable by a user.

14. The container of claim 13 wherein said valve is a quarter-turn valve;
wherein said valve comprises a floating element;
wherein said floating element comprises a first aperture and a second aperture;
wherein said first aperture permits flow through said first fluid passage when in an open position; and
wherein said second aperture permits flow through said second fluid passage when in an open position.

15. The container of claim 14 wherein said floating element is a ball; and
wherein said quarter-turn valve is a ball valve.

16. The container of claim 15 wherein said rotatable control of said ball valve is biased by a spring.

17. The container of claim 16 wherein said spring biases said rotatable control of said ball valve in a closed direction such that when torque is not applied to said rotatable control, said ball valve is pushed into a closed position.

18. The container of claim 8 wherein said body is substantially rectangular shaped in profile;
wherein said rectangular shape of said body comprises two upper corners which are not for being disposed on the ground, and two lower corners which are for being disposed on the ground;
wherein said two upper corners comprise a first upper corner and a second upper corner; and
wherein said spout extends from said first upper corner of said rectangular shaped of said body.

19. The container of claim 18 wherein said second terminus of said second fluid passage is disposed at said second upper corner of said rectangular shape.

20. The container of claim 19 wherein said body further comprises a first handle; and
wherein said first handle is disposed between said first upper corner and said second upper corner.

21. The container of claim 20 wherein said body further comprises a second handle;
wherein said second handle is disposed between said second upper corner and the most proximal of said lower corners to said second upper corner.

22. The container of claim 21 wherein said first handle and said second handle are cut out from said body with said cut outs being sealed.

23. The container of claim 19 wherein said spout is angled such that said distal end of said spout is higher than said second terminus of said second fluid passage when both of said two lower corners are disposed on the ground.

24. The container of claim 10 wherein said spout further comprises a mark;
wherein said body further comprises a mark; and
wherein said mark of said spout and said mark of said body are for being aligned when said spout is attached to said body by said threading such that when said mark of said body and said mark of said spout are aligned, said spout portion of said second fluid passage and said body portion of said second fluid passage are aligned.

25. The container of claim 24 wherein said mark of said spout is disposed on said proximal end of said spout.

26. A method of utilizing a container wherein said container comprises:
a) a body;
b) a first fluid passage;
c) a second fluid passage; and
d) a control means;
e) a spout;
wherein said body is hollow and comprises a chamber for storing a fluid;
wherein said first fluid passage extends from said body;
wherein said second fluid passage extends from said body;
wherein said control means simultaneously controls whether said first fluid passage is open, and whether said second fluid passage is open;
wherein said spout has a proximal end and a distal end;
wherein said proximal end of said spout is attached to said body;
wherein said distal end of said spout is extended away from said body;
wherein said first fluid passage comprises a first terminus and a second terminus;
wherein said second fluid passage comprises a first terminus and a second terminus;
wherein said first terminus of said first fluid passage and said first terminus of said second fluid passage are both at said distal end of said spout of said container;
wherein said first terminus of said first fluid passage is disposed below said first terminus of said second fluid passage at said distal end of said spout;
wherein said control means comprises a valve;
wherein said valve either seals both said first fluid passage and said second fluid passage, or permits flow through said first fluid passage and said second fluid passage;
wherein said second terminus of said first fluid passage is at said proximal end of said spout;
wherein said second terminus of said second fluid passage is inside said body of said container;
wherein said second fluid passage comprises a spout portion and a body portion;
wherein said spout portion of said second fluid passage is in said spout;
wherein said body portion of said second fluid passage is in said body;
wherein said attachment of said proximal end of said spout to said body fluidly connects said spout portion of said second fluid passage to said body portion of said second fluid passage;
wherein said attachment of said spout to said body is by threading so as to permit removal of said spout by a user unthreading said spout, or attachment by threading said spout;
wherein said threading attachment of said spout to said body comprises a single thread so as to cause said body portion of said second fluid passage and said spout portion of said second fluid passage to substantially align when said spout is fully attached to said body;
wherein said spout further comprises a mark;
wherein said body further comprises a mark;
wherein said mark of said spout and said mark of said body are for being aligned when said spout is attached to said body by said threading such that when said mark of said body and said mark of said spout are aligned, said spout portion of said second fluid passage and said body portion of said second fluid passage are aligned;
wherein said method comprises the steps of:
Step A: Removing said spout from said body by unthreading;
Step B: Filling said body with a fluid;
Step C: Attaching said spout to said body by threading;
Step D: Aligning said mark of said spout with said mark of said body;
Step E: Opening said valve of said control means;
Step F: Tilting said body so as to cause the fluid to exit via said first fluid passage;
Step G: Closing said valve of said control means.

27. The method of claim 26 wherein said valve is rotatably controllable by a user;
wherein said rotatable control of said valve is biased by a spring;
wherein said spring biases said rotatable control of said valve in a closed direction such that when torque is not applied to the rotatable control, said valve is pushed into a closed position;
wherein Step G comprises the step of closing said valve of said control means by releasing said rotatable control.
